(19) United States
(12) Patent Application Publication
(10) Pub. No.: US 2016/0369976 A1
(43) Pub. Date: Dec. 22, 2016

(54) Protection Cover for Portable Terminal Having Light Emitting Device Capable of Converting Color

(71) Applicant: LUMINOSO CO., LTD, Seoul (KR)

(72) Inventor: Hyang Sook Lee, Chungcheongbuk-do (KR)

(73) Assignee: LUMINOSO Co., Ltd., Seoul (KR)

(21) Appl. No.: 14/903,446

(22) PCT Filed: Apr. 23, 2014
(86) PCT No.: PCT/KR2014/003558

§ 371 Date: Jan. 7, 2016

(30) Foreign Application Priority Data
Jul. 23, 2013 (KR) 10-2013-0086614

(51) Int. Cl. F21V 11/10; F21V 9/08; F21V 5/00; A45C 11/00; H04B 1/3888

(52) U.S. Cl. CPC F21V 11/10; A45C 11/00; H04B 1/3888; F21V 5/002; F21V 9/083; A45C 2011/002

(57) ABSTRACT

The present invention relates to a light emitting device mounted to a protection cover for a portable terminal and emitting light from a light emitting diode to the outside, the light emitting device comprising: a light source blocking part (10) attached on the inner wall surface of the protection cover (200) for the portable terminal and having a plurality of through-holes (12) formed in a body thereof, the through-holes being spaced apart from each other at a predetermined interval; a plurality of color providing parts (20) through which light from the light emitting diode passes, the color providing parts having different colors and being attached to the through-holes (12), respectively; a light source diffusion part (30) which is formed on the inner wall surface of the protection cover (200) and diffuses the light passing through the color providing parts (20); and a light source reflection part (40) which is hingedly coupled on the outer wall surface of the protection cover (200) and reflects the light, which passes through the color providing parts (20), to the light source diffusion part (30). Therefore, since the light generated by the light emitting diode of the portable terminal is emitted through the protection cover in various colors, the present invention can provide patterns or colors, which a consumer of the protection cover wants, thereby improving the product quality.

### TECHNICAL FIELD

The present invention relates to a light-emitting device mounted on a protective cover of a portable terminal to emit light. More particularly, the present invention relates to a protective cover for a portable terminal having a light-emitting device able to convert light generated by a light-emitting diode (LED) into a variety of colors and provide patterns or symbols desired by a user.

### BACKGROUND ART

In general, a portable terminal is a set of electrical equipment with a user conducts communications while carrying the potable terminal in a hand, a pocket, or a bag. Such portable terminals are widely used as not only a mobile phone directed to communications, but also a small computer, such as a smartphone having enhanced personal communication functions, such as the Internet communications, and a personal digital assistance (PDA).

Such portable terminals may be used in the condition in which they are purchased. However, since portable terminals molded from a synthetic resin are rigid and hard, portable terminals may be easily damaged by impacts, which is problematic. Portable terminals are typically used as received in protective covers in order to prevent flaws, improve an aesthetic appearance, and absorb shocks.

However, while a portable terminal is being carried received in a protective cover, when the portable terminal is set to a vibration mode, is placed in a dark space, or is received in a protective cover protecting both sides of the portable terminal, it is difficult for a user to correctly recognize an incoming call or an incoming text message. This causes inconvenience to the user.

Thus, in order to effectively indicate an incoming call or an incoming text message even in the case in which the portable terminal is received in the protective cover, a variety of light-emitting devices have been developed and are used. Such light-emitting devices provide convenience to users, and examples thereof include a light-emitting diode (LED) lamp provided on the protective cover and a light-emitting display.

In such portable terminals, not only the function but also the design thereof is regarded as a key evaluation factor. No matter how beautifully the portable terminal is designed, the design may become boring after a long period. Thus, the replacement period of portable terminals is being gradually reduced according to consumers' tastes.

Furthermore, even in the case in which convenience is enhanced by adding the light-emitting device to the protective cover, it is difficult to create demand unless an aesthetic appearance or user satisfaction is maximized. In addition, users must continue to purchase protective covers having desirable designs, which is an uneconomic and troublesome problem.

Accordingly, there is an urgent requirement for a research that allows users to convert a pattern or a color into a desirable pattern or color by adding a variety of colors to the light-emitting device provided on the protective cover, whereby an aesthetic appearance or satisfaction can be maximized.

### RELATED DOCUMENT

Registered Utility Model Publication No. 20-0341826 (dated Feb. 14, 2004)

### DISCLOSURE

### Technical Problem

Accordingly, the present invention has been made keeping in mind the above problems occurring in the related art, an object of the present invention is to provide a protective cover for a portable terminal having a light-emitting device able to convert light generated by a light-emitting diode (LED) into a variety of colors and provide patterns or symbols desired by a user.

### Technical Solution

In order to achieve the above object, the present invention provides a protective cover for a portable terminal having a color-converting light-emitting device enabling the protective cover to emit light generated by a light-emitting diode of a portable terminal. The protective cover includes: a light-blocking part attached to the inner wall surface of the protective cover, the light-blocking part having a plurality of passage-holes formed in a body thereof, the plurality of passage-holes being spaced apart from each other at predetermined distances; a plurality of color-providing parts having different colors, the plurality of color-providing parts being respectively attached to the plurality of passage-holes such that light pass therethrough; a light-diffusing part formed on the inner wall surface of the protective cover by machining the inner wall surface to diffuse light passing through the color-providing parts; a light-reflecting part hinge-engaged with the outer wall surface of the protective cover to reflect light passing through the color-providing parts toward the light-diffusing part.

### Advantageous Effects

As set forth above, the protective cover for a portable terminal according to the present invention has a plurality of effects as follows:

First, since light generated by the LED of the portable terminal can be converted into a plurality of colors of light through the protective cover, it is possible to provide a pattern or a color desired by a user of the protective cover, thereby improving the quality of a product.

Second, since the light-diffusing part is hinge-engaged with the protective cover, it is possible to take images using a camera of the potable terminal without removing the protective cover, thereby eliminating inconvenience and maximizing the degree of satisfaction.

Third, since the light-diffusing part having the shape of a desirable character is formed in the inner wall surface of the protective cover by laser machining, small quantity batch production is possible for the protective cover. This can simplify a fabrication process and reduce fabrication costs, thereby leading to economic competitiveness.

### DESCRIPTION OF DRAWINGS

FIG. 1 is an enlarged perspective view illustrating the separated position of a protective cover according to the present invention;

FIG. 2 is an exploded perspective view illustrating a light-emitting device of the protective cover according to the present invention;

FIGS. 3(a) and (b) is a cross-sectional view illustrating the assembled position of the light-emitting device of the protective cover according to the present invention;

FIGS. 4(a) and (b) is a conceptual view illustrating the active position and inactive position of the camera of the protective cover according to the present invention.

<Description of the Reference Numerals in the Drawings>

| | |
|---|---|
| 100: portable terminal | 110: light outlet |
| 200: protective cover | 10: light-blocking part |
| 12: passage-hole | 14: blocking wall |
| 20: color-providing part | 30: light-diffusing part |
| 32: light-diffusing recesses | 40: light-reflecting part |
| 42: light-exposing portion | 44: spacing protrusion |

46: hinge pin

### MODE FOR INVENTION

Hereinafter, reference will be made to an embodiment of the present invention.

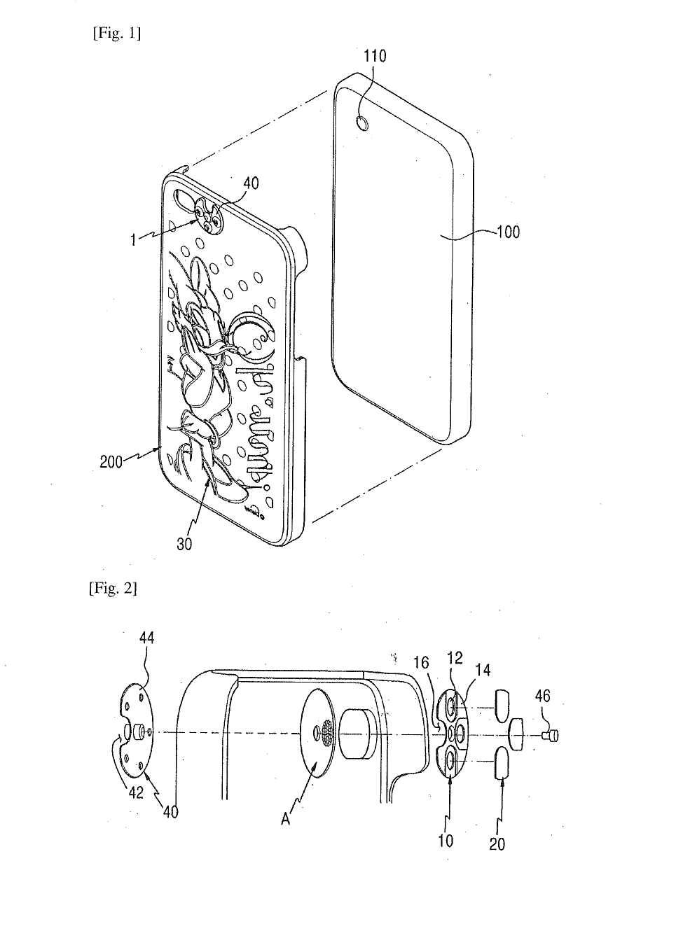

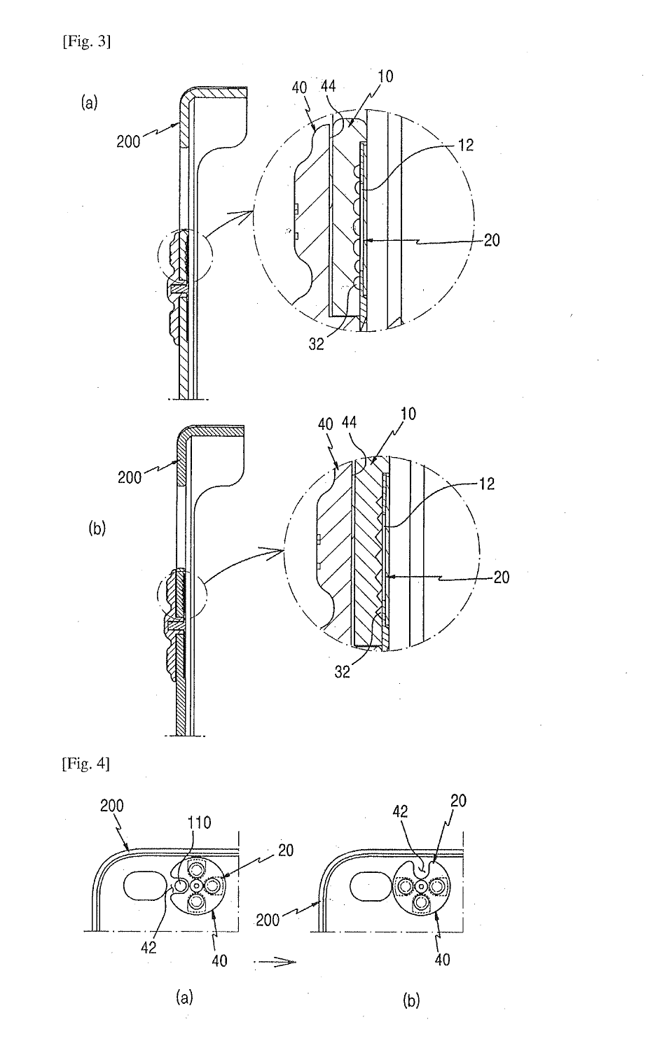

As illustrated in FIG. 1 to FIG. 4, the present invention provides a protective cover 200 for a portable terminal having a color-converting light-emitting device enabling the protective cover 200 to emit light generated by a light-emitting diode of the portable terminal 100. The protective cover 200 includes a light-blocking part 10, a plurality of color-providing parts 20, a light-diffusing part 30, and a light-reflecting part 40. The light-blocking part 10 is attached to the inner wall surface of the protective cover 200. A plurality of passage-holes 12 spaced apart from each other at predetermined distances are formed in the body of the light-blocking part 10. The plurality of color-providing parts 20 having different colors are respectively attached to the plurality of passage-holes 12 such that light pass therethrough. The light-diffusing part 30 is formed on the inner wall surface of the protective cover 200 by machining the inner wall surface to diffuse light passing through the color-providing parts 20. The light-reflecting part 40 is hinge-engaged with the outer wall surface of the protective cover 200 to reflect light passing through the color-providing parts 20 toward the light-diffusing part 30.

First, it is additionally described in that the light-emitting device 1 according to the present invention is characterized in that light emitted from the LED of the portable terminal 100 selectively passes through the light-blocking part 10, is reflected by the light-reflecting part 40, and diffuses to the surroundings through light-diffusing recesses 32 of the light-diffusing part 30.

In addition, the portable terminal 100 means any type of electrical equipment, such as a portable phone, a smartphone, or a personal digital assistant (PDA), that a user can carry with ease or contain in a bag or a pocket. In particular, the portable terminal 100 has a light outlet 110 in the rear surface of the body thereof, the light outlet 110 allowing light generated by the LED to radiate therethrough.

Furthermore, the protective cover 200 is placed over the portable terminal 100 to prevent the portable terminal 100 from being fractured or damaged by external impacts. It is preferable that the protective cover 200 be a transparent member produced by machining a material, such as polycarbonate or urethane.

The protective cover 200 may be formed of any transparent material able to surround the portable terminal 100 without departing from the scope of the present application.

In addition, a mounting site A is formed on the inner wall surface of the protective cover 200, the light-blocking part 10 being disposed in the mounting site A. In particular, a plurality of prism holes are formed in the mounting site A, the plurality of prism holes scatter light such that light is diffused over the entire area of the protective cover.

Furthermore, the light-blocking part 10 is attached to the mounting site A of the protective cover 200 to allow light radiated from the light outlet 110 to pass therethrough or block the same light. The light-blocking part 10 includes a plurality of passage-holes 12 through which light emitted by the LED passes and a blocking wall 14 disposed between the passage-holes 12 to block light emitted by the LED. The passage-holes 12 and the blocking wall 14 are regularly formed at predetermined distances from each other.

In addition, the light-blocking part 10 has a cut portion 16 in a position corresponding to the light outlet 110. The cut portion 16 having a predetermined size is recessed inward.

The light-blocking part 10 serves to fix the plurality of color-providing parts 20, and is formed from an opaque material such that portions light emitted by the LED do not mix with each other.

The plurality of color-providing parts 20 are attached to the passage-holes 12, and allow light generated by the LED to pass therethrough. It is preferable that the plurality of color-providing parts 20 be transparent films or translucent films, and that the plurality of color-providing parts 20 be attached to the plurality of passage-holes by means of double-sided tapes.

It is preferable that the plurality of color-providing parts 20 have at least three colors including blue, pink, and red.

In addition, the light-diffusing part 30 is formed in the inner wall surface of the protective cover 200 by laser machining to diffuse light that has passed through the plurality of color-providing parts 20 and light that has reflected from the light-reflecting part 40. The light-diffusing part 30 has character-shaped light-diffusing recesses 32 scattering light such that light is diffused over the entire area of the protective cover 200.

Here, the light-diffusing recesses 32 are U-shaped recesses or V-shaped channels formed in the inner wall surface of the protective cover 200 by laser machining.

In addition, the light-reflecting part 40 is engaged with the outer wall surface of the protective cover 200, preferably, at a point facing the light-blocking part 10 by means of a hinge pin 46. The light-reflecting part 40 reflects light that has passed through the plurality of color-providing parts 20 and light that has diffused by the prism action of the mounting site A toward the light-diffusing part 30.

Here, it is preferable that the inner wall surface of the light-reflecting part 40 be coated with chromium and be treated to be glossy in order to maximize light-reflecting efficiency.

The light-reflecting part 40 has a light-exposing portion 42 in a position corresponding to the light outlet 110. With this configuration, the camera of the portable terminal 100 can take images in a position in which the protective cover 200 is not uncovered.

In addition, the light-reflecting part 40 has a plurality of spacing protrusions 44 maintaining a predetermined distance from the protective cover 200. The plurality of spacing protrusions 44 also reduce friction with the protective cover 200, thereby properly maintaining the rotational force of the hinge pin 46.

Hereinafter, reference will be made of the operations of the present invention.

First, when the light-emitting device 1 is disposed on the protective cover 200, the process of machining the mounting site A on the inner wall surface of the protective cover 200 and the process of forming the light-diffusing recesses 32 by laser machining are required.

Afterwards, the light-blocking part 10 is fixedly attached to the mounting position A of the protective cover 200, the plurality of color-providing parts 20 having a color or colors desired by a user are attached to the plurality of passage-holes 12 of the light-blocking part 10.

Thereafter, the light-reflecting part 40 is engaged with the outer wall surface of the protective cover 200, i.e. in a position corresponding to the light-blocking part 10, by means of the hinge pin 46, whereby the process of constructing the light-emitting device 1 is completed.

In this manner, light transmitted to the plurality of color-providing parts 20 is diffused by the prism action of the mounting site A and the reflecting phenomenon of the light-reflecting part 40, and in particular, is further diffused along the laser-machined surfaces of the light-diffusing recesses 32.

In addition, since the plurality of color-providing parts 20 having a variety of colors are attached to the plurality of passage-holes 12 of the light-blocking part 10, light passing through the light outlet 110 is radiated with a variety of colors on the protective cover 200 and the surroundings.

In the case of attempting to use the camera of the portable terminal 100, as illustrated in FIG. 4(a), the light-reflecting part 40 is rotated such that the light outlet 110 is exposed. In this position, it is possible to take images without uncovering the protective cover 200.

1. A protective cover (200) for a portable terminal having a color-converting light-emitting device enabling the protective cover (200) to emit light generated by a light-emitting diode of a portable terminal (100), comprising:
a light-blocking part (10) attached to an inner wall surface of the protective cover (200), the light-blocking part (10) having a plurality of passage-holes (12) formed in a body thereof, the plurality of passage-holes (12) being spaced apart from each other at predetermined distances;
a plurality of color-providing parts (20) having different colors, the plurality of color-providing parts (20) being respectively attached to the plurality of passage-holes (12) such that light pass therethrough;
a light-diffusing part (30) formed on the inner wall surface of the protective cover (200) by machining the inner wall surface to diffuse light passing through the color-providing parts (20);
a light-reflecting part (40) hinge-engaged with an outer wall surface of the protective cover (200) to reflect light passing through the color-providing parts (20) toward the light-diffusing part (30),
wherein the light-blocking part (10) has a cut portion (16) in a position corresponding to a light outlet (110), the cut portion (16) allowing light to pass therethrough, and
wherein the light-diffusing part (30) has character-shaped light-diffusing recesses (32) formed in the inner wall surface of the protective cover (200) by laser machining to scatter light such that light is diffused over entire areas of the protective cover (200).

2. The protective cover according to claim 1, wherein the light-blocking part (10) comprises a blocking wall (14) formed between the passage-holes (12) to block light generated by the light-emitting diode.

3. The protective cover according to claim 1, wherein the light-reflecting part (40) comprises a light-exposing portion (42) selectively exposing the light outlet (110) when a camera of the portable terminal (100) takes an image.

4. The protective cover according to claim 1, wherein the light-reflecting part (40) comprises a plurality of spacing protrusions (44) maintaining a predetermined distance from the protective cover (200) and reducing friction with the protective cover (200).
